(19) United States
(12) Patent Application Publication
(10) Pub. No.: US 2017/0354172 A1
(43) Pub. Date: Dec. 14, 2017

(54) SEALED EDIBLE CONTAINER FILLED WITH FREE FLOWABLE POWDER FOOD INGREDIENT

(71) Applicant: NESTEC S.A., Vevey (CH)

(72) Inventors: Annemarie Schoonman, Attalens (CH); Paolo Arancio, Pontarlier (FR); Ishay Vardi, Jongny (CH); Marc Montarras, Pully (CH); Stephane Hentzel, Yvonand (CH); Osvaldo Geromini, Orbe (CH)

(21) Appl. No.: 15/531,166

(22) PCT Filed: Nov. 26, 2015
(86) PCT No.: PCT/EP2015/077749

§ 371 Date: May 26, 2017

(30) Foreign Application Priority Data
Nov. 27, 2014 (EP) 14195209.3

(51) Int. Cl. A23L 7/10; A23P 30/20; A23F 5/26

(52) U.S. Cl. CPC A23L 7/10; A23F 5/26; A23P 30/20; A23V 2002/00

(57) ABSTRACT

The present invention relates to a food product such as a snack comprising at least one sealed edible hollow container filled with free flowable edible solids; wherein the container is configured to release the edible solids in order to be consumed in its present form or reconstituted with a liquid. The present invention also relates to a process of making such a snack. For instance the snack is a cereal-based biscuit filled with an instant coffee powder.

### BACKGROUND

There is an emergence to develop healthy eating snacks which can deliver the required nutritional needs and provide quick and instant food.

Biscuits, wafers and crackers are examples of snacks which are a valuable and convenient form of food enjoyed in nearly every country in the world. They are basically composed of a cereal (usually wheat flour), sugars, and fats with small additions of other materials. There is also an increasing demand for fortified blended foods (FBFs) and high-energy biscuits. FBFs are blends of partially precooked and milled cereals, soya, beans, pulses fortified with micronutrients (vitamins and minerals). Special formulations may contain vegetable oil or milk powder.

There is now extensive evidence emerging mainly from epidemiological studies that a daily intake of three servings of whole grain products, i.e. 48 g of whole grain, is positively associated with decreased risk of cardiovascular diseases, increased insulin sensitivity and decreased risk of type 2 diabetes onset, obesity (mainly visceral obesity) and digestive system cancers. These health benefits of the whole grains are reported to be due to the synergistic role of the dietary fibres and other components, such as vitamins, minerals and bioactive phytochemicals.

Moreover, in recent years, consumers have paid increasing attention to the labelling of food products, and they expect manufactured food products to be as natural and healthy as possible. Therefore, it is desirable to develop food and drink processing technologies and food and drink products that limit the use ofnon-natural food additives, even when such non-natural food additives have been fully cleared by health or food safety authorities. This increasing desire that manufactured food products be as natural and healthy as possible makes it desirable also to be able to reduce the amount of added sugars or other sweeteners, fat without compromising on the taste of the food product.

It is an object of the present invention to provide food products that combines snack and drink product in a combo package such that consumer benefits both these pleasures. This product may be rich in whole grains and in dietary fibers, that provide an excellent consumption experience to the consumer, and that may be easily industrialised at a reasonable cost without compromising the organoleptic parameters.

It would be advantageous to provide food products which have a reduced amount of added sugar, non-sugar sweetener, or artificial sweetener, in particular added sugars, whilst at the same time not compromising organoleptic parameters, particularly the taste, of the product.

DE9305108 relates to portion packaging consisting of 2 parts: one for milk and one for sugar. The reference proposes to use baking ingredients such as used for ice cream cone containing high amount of fat and sugar as portion packaging. The reference is silent about composition of ice cream cones. In general, ice cream cone compositions typically have fat ranging around 8% and sugar levels of minimum 25%.

DE19544019 relates to portion packaging for making drinks. The packaged material is water soluble and intended to be dissolved in the cup to prepare a beverage.

The object of the present invention is to provide a healthy snack which is partly cereal based. One problem encountered in producing cereal-based composition is that cereals tend to absorb moisture and becomes softer and thus presents a challenge to be used as a hollow container to hold edible free flowing powder.

### SUMMARY OF THE INVENTION

Accordingly, in a first aspect the invention relates to a food product comprising a snack comprising at least one sealed edible hollow container filled with a free flowable edible solid; wherein the container comprises a cereal ranging from 30-95% w/w, fat not exceeding 1% and sugar not exceeding 25% w/w of the total dry weight basis of the container composition, wherein the container is configured to release the edible solid to be consumed in its present form or reconstituted with a liquid.

The advantage of the snack of the present invention is that the edible flowable powder is held in an intact manner inside the container during storage and when at use the container may be ruptured in a systematic manner to release the flowable powder and the container may also serve the purpose of being used as a stirrer to prepare the beverage, furthermore the container after stirring may also be consumable as an edible product.

Another aspect of the present invention relates to a process for preparing the food product according to the present invention, said process comprises thermo shaping process comprising extrusion, sintering, wafer and/or biscuit technology to produce the edible solid container; filling this container with a free flowable edible solid and sealing the container to provide a moisture free environment.

### BRIEF DESCRIPTION OF THE DRAWINGS

FIG. 1 shows a sketch of the present invention. The figure represents an example of a complete breakfast solution wherein the invention is an edible hollow biscuit filled with a beverage powder. The biscuit comprises a pre-cut portion to facilitate the rupture of the biscuit in an intact manner to release the beverage powder into a cup. The biscuit can also serve as a stirrer. The snack can be individually wrapped or stacked together in a box. Alternatively the snack product may also be attached to a disposable cup such that the consumer detaches the snack from the disposable cup, snaps the snack to release the edible solids into the cup to prepare a ready-to-drink (RTD) beverage and consumes the edible container as a biscuit.

FIG. 2 shows different embodiments of the present invention. A: shows a cocoa containing biscuit prepared according to recipe 1 as described in table 1 below, both open ends are closed by dipping in chocolate containing nuts; B: shows a vanilla containing biscuit prepared according to recipe 2 as described in table 1 below,.one end is closed by crimping while the other open end is closed by dipping in chocolate; C: shows a oats containing biscuit prepared according to recipe 3 as described in table 1 below, both open ends are closed by dipping in chocolate; D: shows a coffee containing biscuit prepared according to recipe 4 as described in table 1 below,. one end is closed by crimping while the other open end is closed by dipping in chocolate;. The edible solids filled in all the containers A-D is soluble coffee powder or coffee mixes containing coffee, powdered milk powder, sugar and additives (See table 3).

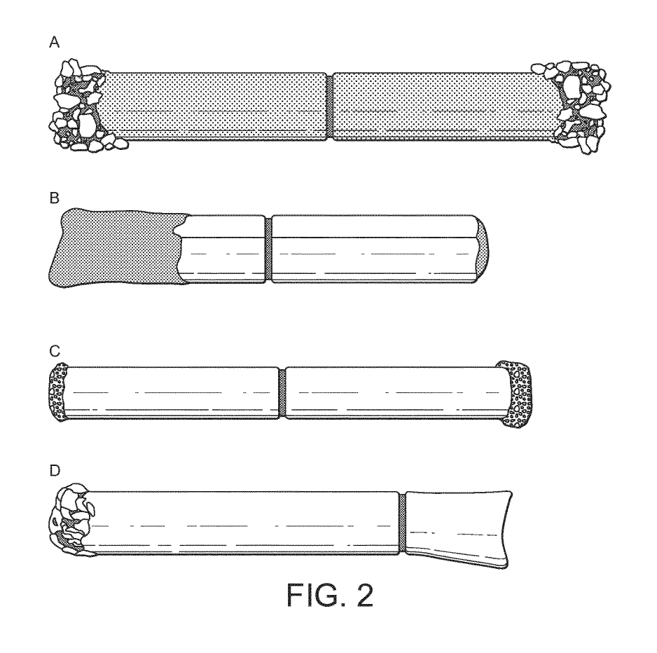

### DETAILED DESCRIPTION OF THE INVENTION

The present invention combines snack and drink product in a combo package such that consumer benefits both the pleasures from one product alone.

Thus in a first aspect, the present invention relates to a food product comprising a snack comprising at least one sealed edible hollow container filled with a free flowable edible solid; wherein the container is configured to release the edible solid to be consumed in its present form or reconstituted with a liquid.

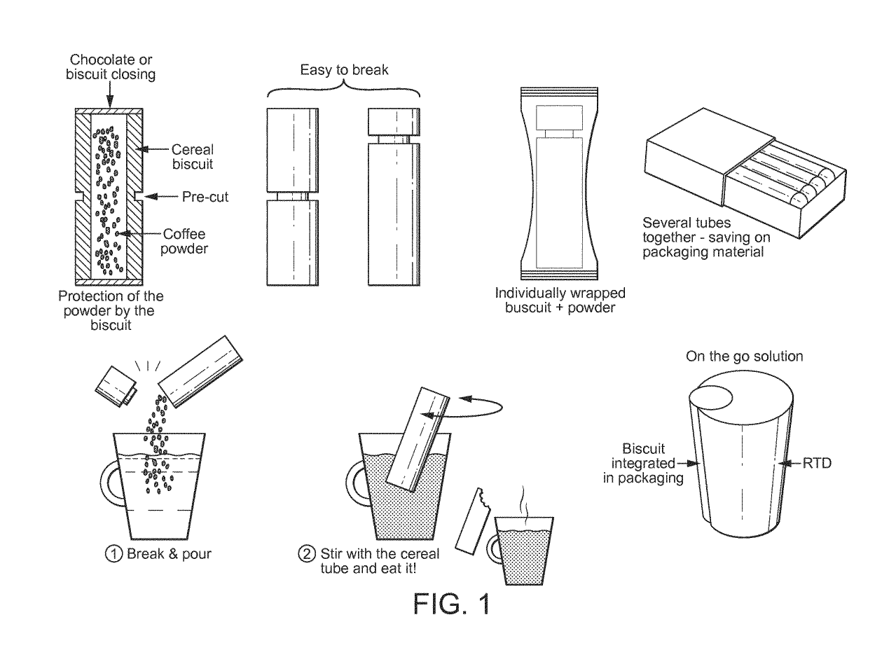

In an embodiment of the present invention, the snack comprises means to rupture the surface of the container to release the edible solids. The term “means” refers to different ways of opening and emptying the container of the edible solids. One way is rupturing the container such as for instance breaking by applying physical pressure/force on the surface of the container such as a snapping action or biting the container. Another way is that the container includes a portion which can be dissolved/melted in order to release the edible solids. For instance a portion of the container may comprise a composition such that this composition dissolves/melts by stirring action in a hot liquid. The container may also comprise a pre-cut segment (see FIG. 1) to facilitate the rupture of the container in an intact manner and at the appropriate position on the surface of the container. The container may also comprise a gas or gas generating composition that reacts upon reconstitution with water to generate or release gas (e.g. acid-base).

In another embodiment of the present invention, the edible hollow container may function as a stirrer or a straw for the reconstituted edible solids.

In an embodiment of the present invention, the snack of the present invention comprising the container and the edible solids have a water activity below 0.5. The water activity may be below 0.3. A conditioning process is applied to bring the water activity of the container to be equivalent to the water activity of the powder that will be filled in the container. For example the conditioning of container such as wafer is exposed to an environment such that a diffusion of moisture takes place.

The term “edible hollow container” may refer to a biscuit, cookie or a wafer. The container may be based on cereal, savory and/or sweet. Such containers may comprise ingredients used in FBFs or high-energy biscuits. The biscuit may comprise a whole grain component obtained from different sources including hydrolysed whole grain. WO2012/076051 describes whole grain composition and hydrolysed forms thus providing a basis for a healthy snack. Examples of whole grain sources are semolina, cones, grits, flour and micronized grain (micronized flour). The whole grains may be ground (milled), preferably by dry milling. Such milling preferably takes place before the whole grain component is contacted with the enzyme composition according to the invention. In an embodiment of the present invention the whole grain component may be heat treated to limit rancidity and microbial count.

In one embodiment of the present, the edible hollow container is a wafer and wherein the sugar in the composition of wafer is less than 10% w/w, for instance less than 7% w/w of the total dry weight basis of the wafer composition.

Whole grains are non-processed cereals of monocotyledonous plants of the Poaceae family (grass family) cultivated for their edible, starchy grains. Examples of whole grain cereals include barley, rice, black rice, brown rice, wild rice, corn (maize), millet, oat, sorghum, spelt, triticale, rye, wheat, teff, canary grass, Job's tears and fonio. Plant species that do not belong to the grass family but which also produce starchy seeds or fruits that may be used in the same way as cereal grains are called pseudo-cereals. Examples of pseudo-cereals include amaranth, buckwheat, tartar buckwheat and quinoa. When designating cereals, this will include both cereal and pseudo-cereals. In general the source of grain used in a recipe depends on the desired product type, since each grain will provide its own taste profile and processing characteristics

Whole grain components are components made from unrefined cereal grains. Whole grain components comprise the entire edible parts of a grain; i.e. the germ, the endosperm and the bran. Whole grain components may be provided in a variety of forms such as ground, flaked, cracked or other forms, as is commonly known in the milling industry.

The container may also contain additional flavoring agents such as coffee, chocolate, vanilla, cinnamon, fruit which enhances the smell of the product. Often these flavors partly disappear during the baking process. Therefore in one embodiment precursors are added to generate flavors during the heating or baking process. For instance in-process flavor generation could be obtained through a Maillard reaction using amino acid and Thiamin based precursors. The cereal-based container may also contain healthy substances like vitamins, minerals, antioxidants, fibers, bioactives, healthy oils, fruits, herbs, plants, milk solids, nuts. For instance if the edible solid is a soup powder, the edible container may be a salty savory biscuit to complement the soup beverage.

Such edible hollow container may be produced by a thermo shaping process including extrusion, sintering wafer and/or biscuit technology.

The term “sealed edible hollow container” may refer to sealing both or at least one end of the container. For instance Extrusion process may produce an edible hollow container with one open end wherein the container can be filled with edible solids and this open end may be sealed with a hydrophobic or hydrophilic material or a blend of both. For instance, the open end of edible hollow container may be closed with a blend of polysaccharides, fat and proteins. In another instance the container may be cylindrical/barrel shaped having open ends on both sides and both ends are sealed with a hydrophobic or hydrophilic material or a blend of both. These substances apart from providing a sealing for the container also functions to keep the edible solids inside the container in a dry form. In another embodiment the edible hollow container are produced using wafer technology wherein edible hollow containers consists of two halves wherein one half is filled with the edible solid and subsequently sealed with the other half of the wafer.

The term “hydrophobic material” refers to any fat or oil containing substances such as vegetable fat, milk fat, animal fat, bees wax or combinations thereof. One form of vegetable fat may be cocoa butter.

The term “hydrophilic material” refers to substances such as sugars, salts, hydrocolloids, hydrophilic polymers like starch, alginate, carrageenan, carboxymethylcellulose, gum arabic, chitosan, pectin, and xanthan gum.

The term “edible solids” refers to a free-flowable dehydrated food product in powder or sphere or granular form which stays dry in the hollow container and can be released by rupturing the surface of the container. Edible solids may refer to beverage ingredients such as coffee, coffee mixes, tea, chocolate powder, soups etc. Coffee such as soluble coffee in all known blends, coffee mixes with cream and/or sugar, roast and ground and/or micronized form Edible solids may also comprise aromatizing agent in order to prepare aromatized drinks such as fruit flavoured water, or coffee, cocoa or vanilla flavoured milk, for example. The present aromatizing agent may also be used in addition to a dehydrated food product to be reconstituted in water, such as soups and sauces, especially powdered soups and sauces or instant noodles, or in milk, such as nutritious, especially powdered cocoa beverages, for example.

The term “free-flowable” refers to the dry nature of the edible solids such that the edible solids are released from the edible container such that the edible hollow container is emptied.

In an embodiment ofthe present invention, the edible hollow container comprises a cereal extruded biscuit filled with soluble coffee as edible solids.

In another embodiment of the present invention, the snack product comprises at least three sealed edible hollow containers filled with a free flowable beverage powder, wherein first one comprises coffee, second one comprises cream and third comprises sugar.

It should be noted that embodiments and features described in the context of one of the aspects or embodiments of the present invention also apply to the other aspects of the invention. The invention will now be described in further details in the following non-limiting examples.

### EXAMPLES

### Example 1

The dry ingredients are mixed according to the formulations given in table 1 below. Four different recipes were prepared. The mix is fed to a cooking extruder where powders are mixed with water and then cooked through the extrusion process. Extrusion temperature profile is spread in the range of 20 to 145° C. (Product temperature may range between 120-180° C.). Screw speed of 260 RPM (180-400 RPM). The process conditions for each of the recipes are defined in table 2 below.

The hot product is pushed out of the extruder, creating a pressure at the die exit (Product pressure, table 2). Coming out of the die, the pressure drops to ambient (1 atmosphere) and with the instant water evaporation the product expand and dry out to create the final product, a tube in this case. The Product is cut to pieces and then dry in a drying oven to <3% moisture. In some cases the product was crimped on one edge, to give only one opened edge.

The resulted tubes, opened on one or two edges. If two edges were opened then one was closed by dipping into chocolate, let cool to solidify. Powder filling was done manually by filling and weight control to assure correct amount of filling. The yet opened edge was now blocked by a fragile piece of biscuit and then sealed by dipping into chocolate.

TABLE 1

| Formulations— | | | | |
|---|---|---|---|---|
| Trial group | | | | |
| 17602 | Recipe 1 | Recipe 2 | Recipe 3 | Recipe 4 |
| Name | Quantity | Quantity | Quantity | Quantity |
| Starch Corn | 32.000 | 36.000 | | 35.400 |
| Vanillin | | 0.040 | 0.040 | 0.400 |
| Bran Oat | | | 30.000 | |
| Flour Wheat | 22.500 | 22.460 | | 22.000 |
| Flour Oat | | | 68.360 | |
| Sugar White Fine | 21.000 | 21.000 | | 20.510 |
| Tocopherol Mix | | | 0.050 | |
| Salt NaCl | 0.200 | 0.200 | 0.600 | 0.200 |
| Maltodextrin | 19.700 | 19.700 | | 19.400 |
| DE 12-16 | | | | |
| Calcium | 0.600 | 0.600 | 0.500 | 0.590 |
| Carbonate | | | | |
| Cocoa Powder | 4.000 | | | |
| Alk 10-12% Fat | | | | |
| Di Potassium | 0.000 | | 0.450 | |
| Phosphate | | | | |
| Coffee | | | | 1.5 |
| Total | 100.000 | 100.000 | 100.000 | 100.000 |

TABLE 2

| | | | | Recipe 2 | | Recipe 4 |
|---|---|---|---|---|---|---|
| | | | Recipe 1 | with no | Recipe 3 | with Coffee |
| Area | Parameters | Units | with Cocoa | Cocoa | Oats | powder |
| Extruder | | — | BC45, 4 | BC45, 4 | BC45, 4 | BC45, 4 |
| | | | barrels | barrels | barrels | barrels |
| | Dry mix | Kg/h | 70 | 70 | 70 | 70 |
| | rate | | | | | |
| | Water rate | L/h | 2.5 | 2.5 | 2.5 | 2.5 |
| | Screw speed | rpm | 260 | 260 | 260 | 260 |
| | Barrel T° z1 | ° C. | 20 | 20 | 20 | 20 |
| | Barrel T° z2 | ° C. | 105 | 105 | 105 | 105 |
| | Barrel T° z3 | ° C. | 125 | 125 | 125 | 125 |
| | Barrel T° z4 | ° C. | 145 | 145 | 145 | 145 |
| | Product | bar | 85 | 85 | 85 | 113 |
| | Pressure | | | | | |
| | Product | ° C. | 165 | 166 | 165 | 165 |
| | Temperature | | | | | |
| Dryer | Temperature | ° C. | 120 | 120 | 150 | 120 |
| | Time in | Min. | 15 | 15 | 01:30 | 15 |
| | drying | | | | | |
| Final | Moisture | % | 1.57 | 1.9 | 2.1 | 1.94 |
| product | after | | | | | |

TABLE 3
Final composition (gr).

| Material | Cocoa | Vanilla | Oats | Coffee |
|---|---|---|---|---|
| Tube, Recipe 1 | 11.5 | | | |
| Tube, Recipe 2 | | 11.0 | | |
| Tube, Recipe 3 | | | 8 | |
| Tube, Recipe 4 | | | | 11 |
| Powder 3 in 1 | 17.5 | 14.0 | 17 | 17 |
| (Coffee, Milk, Sugar) | | | | |
| Chocolate for Closing | 4 | 6 | 4 | 4 |
| and decoration | | | | |
| Flakes | 1 | — | 1 | 1 |
| Total | 34.0 | 31 | 30 | 33 |

### Example 2

Snacks of the present invention may be prepared using wafer technology. Hollow wafers may be prepared using a batter mix as described in example 1 (referring to recipes 1 to 4) except the recipe comprises a blend of at least two cereals such as wheat and corn in the range of 40% and water in range of up 60%. One example of wafer composition is as follows.

| Ingredients | % of dry weight |
|---|---|
| Wheat flour | 66 |
| Corn flour | 13 |
| Oat flour | 9 |
| sugar | 7 |
| oil | 0.9 |
| salt | 0.35 |
| Sodium bicarbonate | 0.25 |
| flavors | 3.5 |

The mix is added on the wafer plates in an oven and baked at 185-200° C. for 2-3 minutes. Two hollow wafer plates are produced and the free flowable edible is added to one of the wafer plates and the sealing is performed with the other wafer plate using a food grade sticking solution (for example a sugar concentrate). The sealed plates are cut and packaged as individual wafer units containing the edible solids.

1. A snack comprising: at least one sealed edible hollow container filled with a free flowable edible solid;
wherein the container comprises a cereal ranging from 30-95% w/w, fat not exceeding 1% and sugar not exceeding 25% w/w of the total final composition; and,
the container is configured to release the edible solid to be consumed in its present form or reconstituted with a liquid.

2. The snack of claim 1, wherein the container comprises a member to rupture the surface of the container to release the edible solid.

3. The snack of claim 1, wherein to rupture a surface of the container physical pressure is applied on the surface of the container or the container includes a portion which can be dissolved.

4. The snack of claim 2 further comprises a pre-cut segment to facilitate the rupture of the container.

5. The snack of claim 1, wherein the water activity of the edible solids and the container is below 0.5.

6. The snack of claim 1, wherein the water activity of the edible solids and the container is below 0.3.

7. The snack of claim 1, wherein the container comprises an ingredient selected from the group consisting of a biscuit, cookie and a wafer.

8. The snack of claim 7 comprises a biscuit selected from the group consisting of cereal, savory and sweet biscuit.

9. The snack of claim 1, wherein the container is sealed with a material selected from the group consisting of a hydrophobic material, hydrophilic material and combinations thereof.

10. The snack of claim 9, wherein the hydrophobic material comprises fat or oil containing substances.

11. The snack of claim 1, wherein the edible solids comprises a food product.

12. The snack of claim 11, wherein the edible solids is a beverage powder and wherein the beverage powder is coffee and wherein the coffee is soluble in all blends, mixes with cream and/or sugar, roast and ground and/or micronized form.

13. The snack of claim 1, wherein the container comprises a cereal extruded biscuit filled with coffee.

14. The snack of claim 1 comprising three sealed edible hollow containers filled with a free flowable beverage powder, wherein first one comprises coffee, second one comprises milk powder and third comprises sugar.

15. A process for producing a snack comprising the steps of
thermo shaping process including extrusion, sintering, wafer and/or biscuit technology to produce the edible hollow container;
determine the moisture content of the edible hollow container and the free flowable edible solid such that the water activity of the edible solids and the container is below 0.5;
adjusting the moisture content of the edible hollow container to match the moisture content of the free flowable edible solid;
filling the container with a free flowable edible solid; and
sealing the container to provide a moisture free environment.
